(19) United States
(12) Patent Application Publication
(10) Pub. No.: US 2017/0019472 A1
(43) Pub. Date: Jan. 19, 2017

(54) SCREEN SHARING SYSTEM, INFORMATION PROCESSING APPARATUS AND STORAGE MEDIUM

(71) Applicant: TOSHIBA TEC KABUSHIKI KAISHA, Tokyo (JP)

(72) Inventor: Shigeo Uchida, Mishima (SG)

(21) Appl. No.: 14/801,105

(22) Filed: Jul. 16, 2015

(51) Int. Cl. H04L 29/08; H04L 29/06

(52) U.S. Cl. CPC H04L 67/1095; H04L 67/148; H04L 67/42

(57) ABSTRACT

According to one embodiment, a first client device updates a display on a first screen in accordance with an operation of a user, and transmits, together with identification information of the first screen, information relating to the operation of the user. A storage unit stores correspondence information in which the identification information of the first screen is correlated with identification information of plural client devices. A control unit specifies a second client device from the correspondence information stored in the storage unit and the information transmitted from the first client device, and transmits the identification information of the first screen and the information relating to the operation. A second client device updates to make a display on the first screen identical to the display on the first screen displayed in the first client device in accordance with the received information relating to the operation.

### FIELD

Embodiments described herein relate generally to a technique to share a display screen among plural terminals.

### BACKGROUND

Hitherto, there is a method in which a screen displayed on a terminal is shared with a screen of another terminal, and contents operated on the respective screens are reflected on the screen of the other terminal in real time. In this system, in order to cause the result of a screen operation to be reflected in real time, data is classified into a document, an image and a sounds, and identifiers of those and a generation order are transmitted as a message to the respective terminals and are displayed.

In the related art system, as a transmission mode, broadcast to all terminals or transmission of data to only a specific terminal can be selected. Even when a meeting is shared, data transmission can be limited to only a specific terminal.

However, in the related art system, although the transmission destination can be limited in one-way communication, transmission and reception destinations can not be limited in two-way communication. For example, a description will be made about an example in which there are terminals A, B and C, and displays of only the terminal A and the terminal B are linked. In the related art system, the terminal A limits the transmission destination to only the terminal B, and can transmit data to only the terminal B. That is, the operation content of the terminal A can be reflected on the display of the terminal B side in real time. However, the terminal B at the reception side can not limit the transmission destination to the terminal A. Thus, the content operated in the terminal B is transmitted to not only the terminal B but also the terminal C, and the operation content is reflected also on the display of the terminal C.

### DESCRIPTION OF THE DRAWINGS

FIG. 1 is a view showing a system structure example of an embodiment.

FIG. 2 is a view showing a structure example of a server of the embodiment.

FIG. 3 is a view showing a structure example of a client PC (Personal Computer) used by a meeting organizer.

FIG. 4 is a view showing a structure example of a client PC used by a meeting participant.

FIG. 5 is a view showing a screen display example of a client PC.

FIG. 6A is a view exemplifying screen layout information, and FIG. 6B is a view showing a table example in which a screen ID, a meeting ID, a participant ID and a participation PC are correlated.

FIG. 7 is a view showing an object layout example displayed in one screen.

FIG. 8 is a view exemplifying object layout information.

FIG. 9 is a flowchart showing an operation example of a client PC.

FIG. 10 is a flowchart showing the operation example of the client PC.

FIG. 11 is a flowchart showing the operation example of the client PC.

FIG. 12 is a flowchart showing an operation example of a server.

FIG. 13 is a flowchart showing the operation example of the server.

FIG. 14 is a flowchart showing an operation example when a client PC participates in a meeting.

FIG. 15 is a flowchart showing the operation example when the client PC participates in the meeting.

FIG. 16 is a flowchart showing an operation example in which another screen is reduced when a new meeting is held.

FIG. 17 is a flowchart showing an operation example in which in order to return a reduced display screen to an original large screen display, another screen is reduced when a new meeting is held.

FIG. 18 is a flowchart showing an operation example in which in order to return a reduced display screen to an original large screen display, after a meeting screen is deleted, the reduced display screen is returned to the original large screen display.

### DETAILED DESCRIPTION

In general, according to one embodiment, a screen sharing system includes a first client device, a storage unit, a control unit and a second client device. The first client device updates a display on a first screen in accordance with an operation of a user, and transmits, together with identification information of the first screen, information relating to the operation of the user. The storage unit stores correspondence information in which the identification information of the first screen is correlated with identification information of plural client devices including the first client device. The control unit acquires the information relating to the operation and the identification information of the first screen from the first client device. The control unit acquires one or plural pieces of identification information of the client devices from the correspondence information stored in the storage unit and the identification information of the first screen. The control unit transmits the identification information of the first screen and the information relating to the operation to one or plural client devices corresponding to the acquired identification information of the client device. The second client device is the client device correlated with the first screen by the correspondence information, receives the identification information of the first screen and the information relating to the operation, and updates to make a display on the first screen identical to the display on the first screen displayed in the first client device in accordance with the information relating to the operation.

In the embodiment, a screen sharing system including plural terminals (client PCs) will be described. Besides, a situation in which a meeting is performed using the screen sharing system will be described as an example.

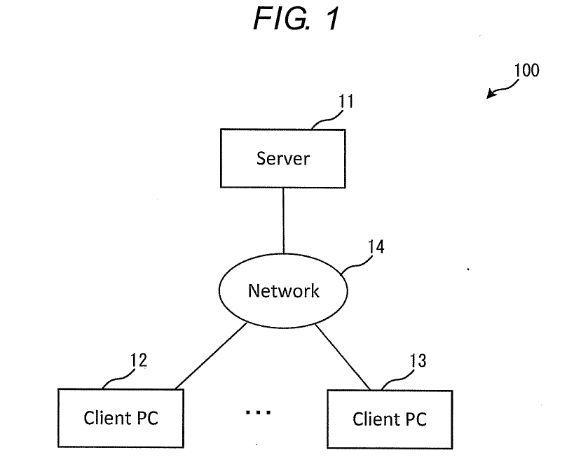

FIG. 1 is a structure view of a system for realizing the embodiment. A screen sharing system 100 includes a server 11 and plural client PCs 12 and 13. The server 11 and the client PCs 12 and 13 are connected via a network 14. The network 14 is the Internet or a LAN (Local Area Network).

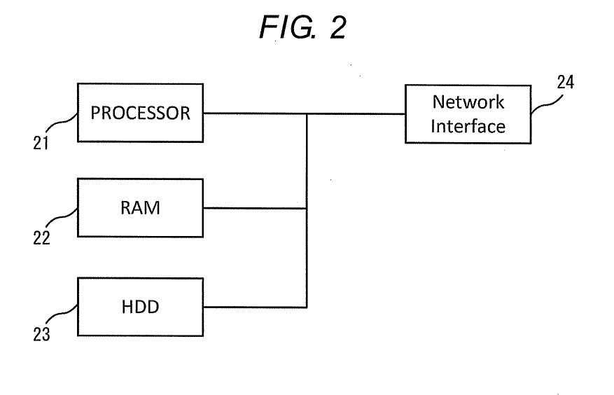

FIG. 2 is a block diagram showing a structure example of the server 11. The server 11 includes a processor 21 to perform processing such as data control and operation. The server 11 includes a RAM 22 as a main storage device to temporarily store data to be processed by the processor 21. The server 11 includes a HDD 23 as an auxiliary storage device to store data and programs for a long time. The server 11 includes a network interface 24 which outputs data to the network 14 and inputs data from the network 14.

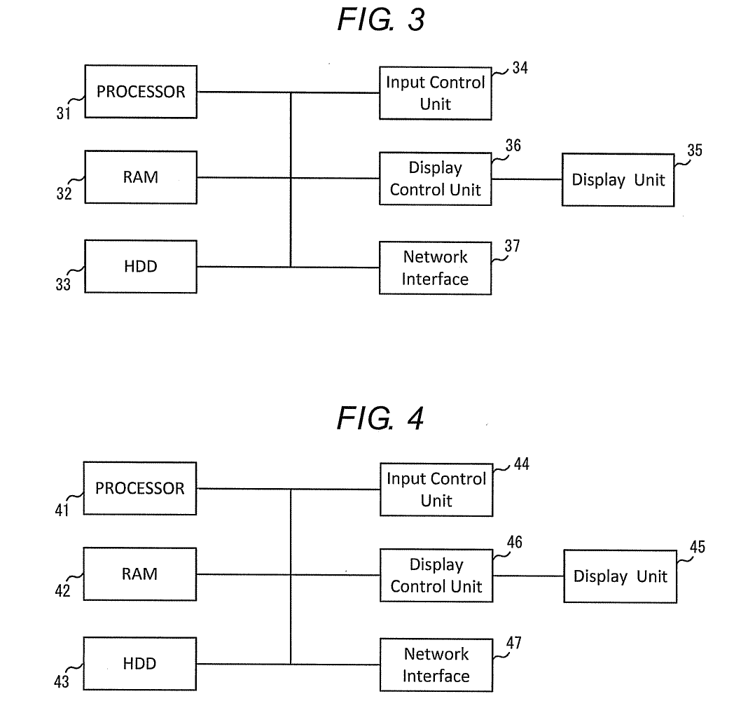

FIG. 3 is a block diagram showing a structure of the client PC 12 used by a person who organizes a meeting. The client PC 12 includes a processor 31 to perform processing such as data control and operation. The client PC 12 includes a RAM 32 as a main storage device to temporarily store data to be processed by the processor 31. The client PC 12 includes a HDD 33 as an auxiliary storage device to store data and programs for a long time. Further, the client PC 12 includes an input control unit 34 to control an input device such as a keyboard or a touch panel, and a display control unit 36 to control a display unit 35 for displaying information. The client PC 12 includes a network interface 37 which outputs data to the network 14 and inputs data from the network 14.

FIG. 4 is a block diagram showing a structure example of the client PC 13 used by a person who participates in the meeting. Similarly to the client PC 12, the client PC 13 includes an input control unit 44, a display unit 45, a display control unit 46 and a network interface 47.

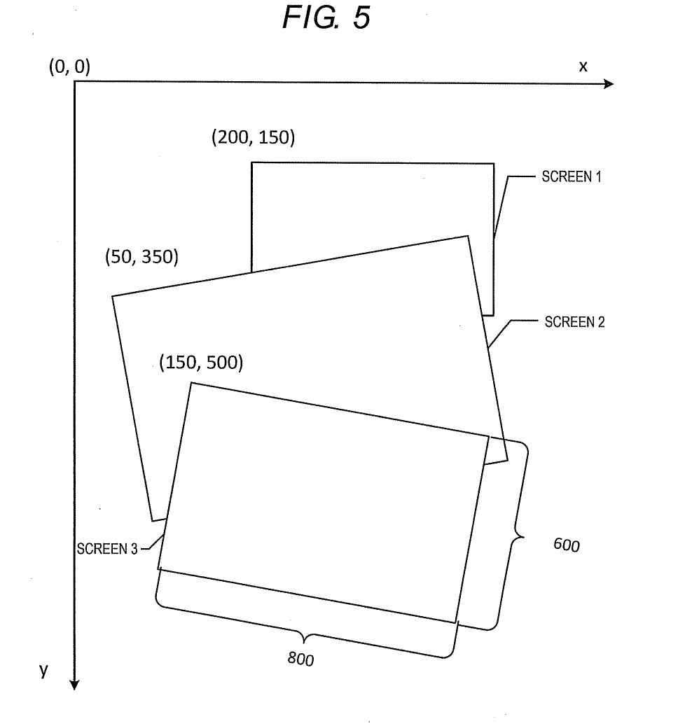

Here, a display example of the client PCs 12 and 13 and a data structure example of display data will be described by use of FIG. 5 to FIG. 8. In the embodiment, screens displayed in the client PCs 12 and 13 have the same display content. Besides, when an operation is made in one client PC in the system 100 and display content is updated in the screen, also in the other client PC participating in the same meeting, the same update display is interlockingly performed. Incidentally, in a client PC not participating in the same meeting, the interlocking is not performed. Here, although the display example and the operation example of the client PC 12 will be described, the same display and operation can be performed also in the client PC 13.

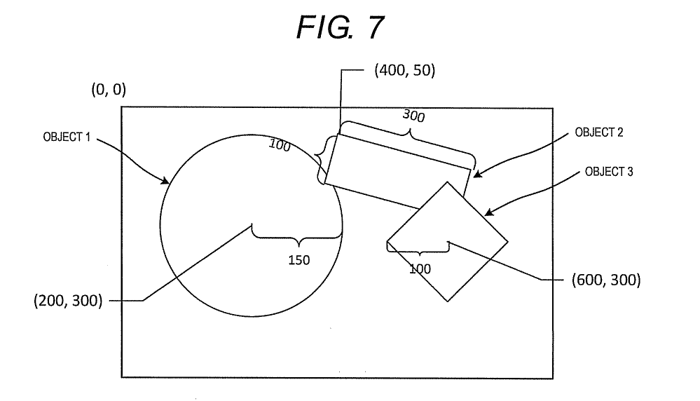

FIG. 5 shows an example of a screen layout displayed on the client PC 12. In the embodiment, as shown in FIG. 5, one window screen (hereinafter simply called a screen) is assigned to each meeting and can be displayed. Besides, the client PC 12 can simultaneously display plural meeting screens. A material image (called an object) used in the meeting is arranged in each screen (see FIG. 7 mentioned later). The user clicks and selects one of the displayed screens by the input device and can display the screen on this side (front surface). The user can move and display the screen by dragging the screen displayed on this side and by performing slide movement. The user can rotate the screen by dragging the screen displayed on this side and by performing a specified operation. Further, the user can change the size of the screen by dragging an edge of the screen by the input device and by moving the edge in the state.

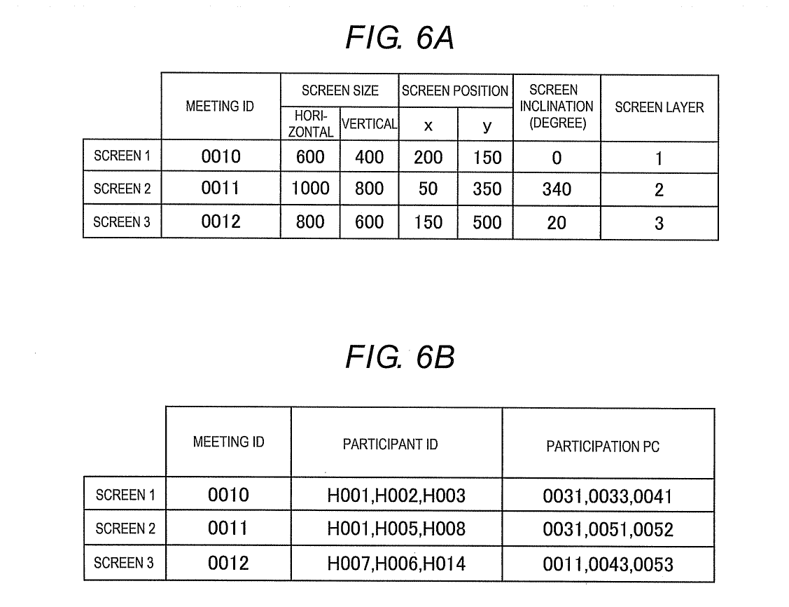

FIG. 6A shows layout information corresponding to the screen layout of FIG. 5. The screen layout information is stored in each of the server 11 and the client PCs 12 and 13, and is interlockingly updated. Incidentally, the server 11 stores the screen layout information of all meetings, and the client PCs 12 and 13 store the screen layout information of only the meeting in which the client PCs participate. In FIG. 6A, one record of the screen layout information includes a meeting ID corresponding to each screen, vertical and horizontal sizes of a screen size, (x, y) coordinates expressing an upper left position of the screen, an inclination of the screen and a numeral of a screen layer expressing a layer relation between the screens. A screen having a larger value of the screen layer is displayed on this side.

FIG. 6B shows a table exemplifying a correspondence relation among a screen ID such as a screen 1 or a screen 2, a meeting ID, a participant ID and a participation PC. The participation PC is a user ID participating in the meeting, and the participation PC is information to identify the client PC connected to the meeting. When the meeting is held or ended, the table is updated. Besides, also when a new user or a new client PC participates in an existing meeting or leaves the seat, the table is updated. This table is stored in the server 11.

FIG. 7 shows a layout example of respective objects displayed in one screen (for example, in a screen 3 of FIG. 5). The coordinate system of FIG. 7 is a relative coordinate system in which the upper left corner of the screen is (0, 0) and is a coordinate system in which the screen is not rotated (the screen inclination of FIG. 6 is 0). Similarly to the screen shown in FIG. 5, the front surface display operation, movement, rotation operation, and size change operation can be performed also for each object.

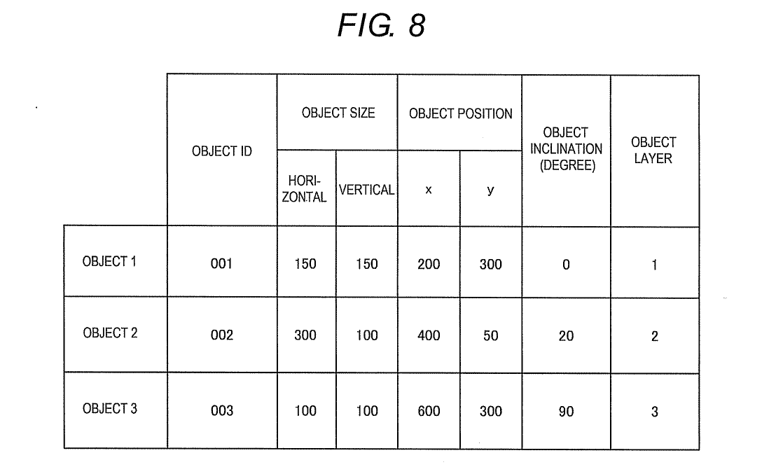

FIG. 8 shows object layout information corresponding to the object layout of FIG. 7. This information is prepared for each screen and is stored in each of the server 11 and the client PCs 12 and 13. This information is updated when an operation is performed in one client PC, and the display content is also updated. Besides, when the information is updated in one client PC, the information is interlockingly updated also in the other client PC. Incidentally, the server 11 stores the object layout information of all screens, and the client PCs 12 and 13 store the object layout information of only the screen of the meeting in which the cline PC participates. One record of the object layout information includes an object ID to uniquely identify an object, and horizontal size and vertical size of the object. Besides, the one record includes (x, y) coordinates expressing a position of the object, an inclination of the object, and a numeral of an object layer expressing a layer relation between the objects. An object having a larger value of the object layer is displayed on this side.

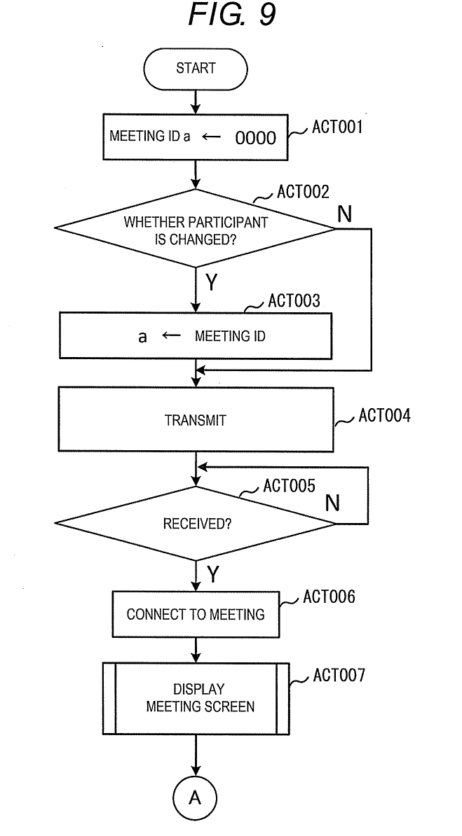

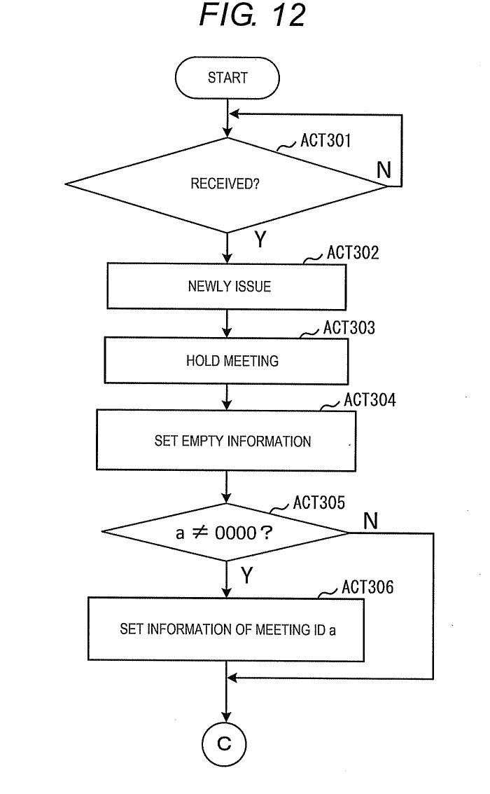

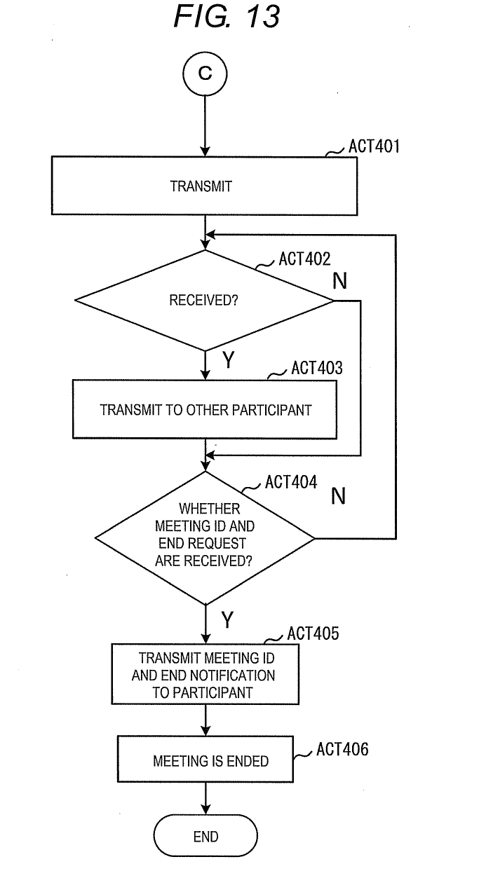

Next, by use of FIG. 9 to FIG. 13, a description will be made about a procedure in which a meeting is held among the client PCs 12 and 13 and the server 11 and screens are shared among the meeting participants. FIG. 9 to FIG. 11 show an operation of the client PC 12, and FIG. 12 and FIG. 13 show an operation of the server 11. In FIG. 9, the client PC 12 initializes a variable “a” (hereinafter called a meeting ID “a”) storing an ID of a meeting to “0000” (ACT001). Next, when a participant of a meeting already being held is changed (ACT002, Y), a meeting ID of the meeting being held is set in the meeting ID “a” (ACT003). The client PC 12 transmits a meeting holding request, a value of the meeting ID “a”, and meeting participant information (screen sharing person information such as a user ID) to the server 11 (ACT004).

In FIG. 12, when receiving the meeting holding request, the value of the meeting ID “a” and the meeting participant information from the client PC 12 (ACT301, Y), the server 11 newly issues a variable “b” (hereinafter called a meeting ID “b”) indicating a meeting ID in order to prevent overlapping of IDs (ACT302), and holds the meeting (ACT303). Thereafter, the server 11 once initializes the object layout information of the meeting ID “b” to empty information (ACT304). The server 11 confirms whether or not the meeting ID “a” is “0000” (ACT305). If the meeting ID “a” is not “0000” (ACT305, Y), the operation is for changing the participant of the meeting already being held. Thus, the server 11 sets, as the object layout information of the meeting ID “b”, the object layout information of the meeting set in the meeting ID “a” (ACT306). On the other hand, if the meeting ID “a” is “0000” (ACT 305, N), since the meeting is newly held, ACT306 is skipped. That is, the object layout information for the meeting ID “b” remains empty.

Then, the server 11 transmits the newly issued meeting ID “b” and the object layout information set at ACT304 or ACT 306 to the client PCs 13 of all meeting participants in addition to the client PC 12 transmitting the meeting holding request (ACT401 of FIG. 13). Here, the server 11 refers to the information shown in FIG. 6B, and specifies the client PC as the transmission destination based on the meeting ID “b”.

In FIG. 9, when receiving the meeting ID “b” and the object layout information from the server 11 (ACT005, Y), the client PC 12 connects to the meeting in which the received meeting ID is “b” (ACT006), and displays a meeting screen in which objects are arranged in accordance with the received object layout information (ACT007).

Thereafter, when detecting a screen operation (ACT101, Y), the client PC 12 updates the screen of the client PC 12 in accordance with the operation (ACT102). Besides, when detecting an object operation (ACT103, Y), the client PC 12 updates the screen by moving, rotating or resizing the object on the screen in accordance with the detected object operation content (ACT104). When the respective operations are performed, the client PC 12 transmits the meeting ID corresponding to the operated meeting screen and the object operation information to the server 11 (ACT105). The object operation information includes information relating to size change, position movement, inclination change and object layer numeral change with respect to the object ID.

In FIG. 13, when receiving the meeting ID “b” and the object operation information from the client PC 12 (ACT402), the server 11 refers to the participant information of the meeting ID “b” by using the table shown in FIG. 6B, and transmits the meeting ID “b” and the object operation information to other participants (ACT403).

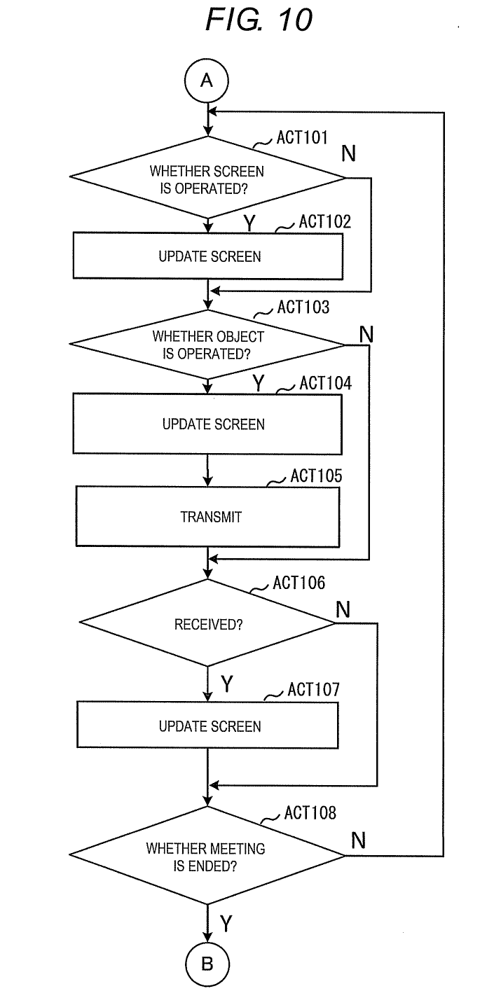

Besides, in FIG. 10, when receiving the meeting ID “b” and the object operation information from the server 11 (ACT106, Y), the client PC 12 moves the object and updates the screen in accordance with the received object operation information on the meeting screen (ACT107).

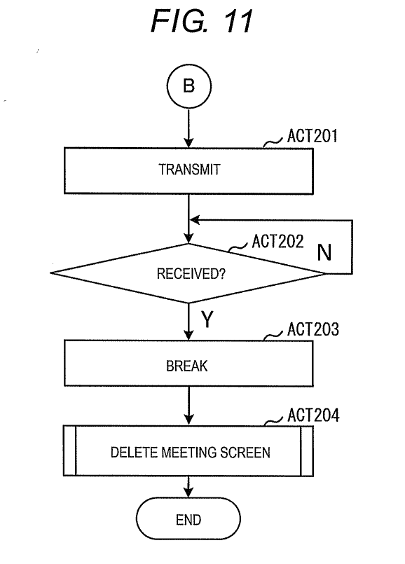

In FIG. 10, when the meeting is ended (ACT108, Y), the client PC 12 of the meeting organizer transmits the meeting ID of the meeting to be ended and a meeting end request to the server 11 (ACT201 of FIG. 11). In FIG. 13, when receiving the meeting ID to be ended and the meeting end request from the client PC 12 (ACT404, Y), the server 11 transmits the meeting ID to be ended and a meeting end notification to the client PC 12 of the meeting organizer and the client PCs 13 of all the meeting participants included in the meeting participant information (ACT405), and ends the meeting.

In FIG. 11, when receiving the meeting ID and the meeting end notification (ACT202), the client PC 12 breaks the connection to the meeting of the received meeting ID (ACT203), deletes the meeting screen (ACT204), and ends the meeting.

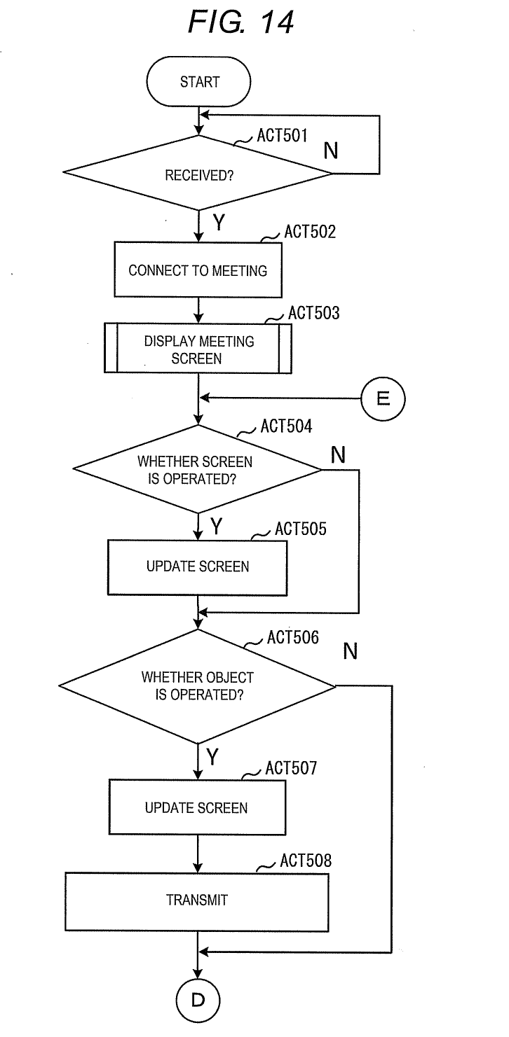

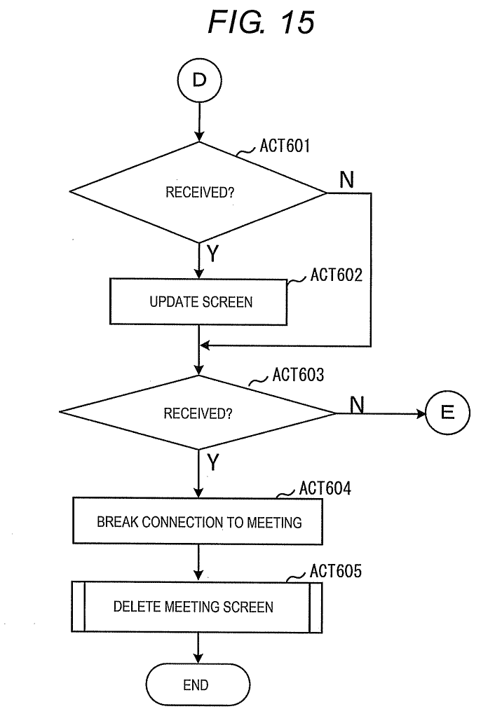

Next, a procedure in which the client PC 13 participates in the meeting will be described by use of FIG. 14 and FIG. 15. First, in FIG. 14, when receiving the participation meeting ID “b” and the object layout information from the server 11 (ACT501, Y), the client PC 13 connects to the meeting of the received meeting ID “b” (ACT502), arranges the object in accordance with the received object layout information and displays the meeting screen (ACT503).

Thereafter, when detecting a screen operation on the client PC 13 (ACT504, Y), the client PC 13 updates the screen in accordance with the screen operation (ACT505). Besides, when detecting an object operation on the client PC 13 (ACT506, Y), the client PC 13 moves the object on the screen and updates the screen in accordance with the detected object operation content (ACT507). The client PC 13 transmits the meeting ID corresponding to the meeting screen on which the object is operated and the object operation information to the server 11 (ACT508).

In FIG. 15, when receiving the meeting ID “b” and the object operation information based on the operation of the other client PC from the server 11 (ACT601, Y), the client PC 13 updates the screen by moving, rotating, resizing the object in accordance with the object operation information on the meeting screen corresponding to the meeting ID “b” (ACT602). This processing is continued until a meeting end notification is received (ACT603, loop of N).

When receiving the meeting ID and the meeting end notification (ACT603, Y) from the server 11, the client PC 13 breaks the connection to the meeting of the received meeting ID (ACT604), deletes the meeting screen (ACT605), and ends the meeting.

By adopting the structure as described above, the meeting system (screen sharing system) can be realized in which the transmission and reception destinations are limited not only at the time of one-way data transmission from the terminal PC but also at the time of two-way data communication between plural terminals.

In the above description, the client PC 12 or the client PC 13 transmits the meeting ID and the object operation information to the server 11. However, when the information is transmitted and received between the client PCs 12 and 13 without passing through the server 11, a delay required until the object operation is reflected on the screen can be reduced.

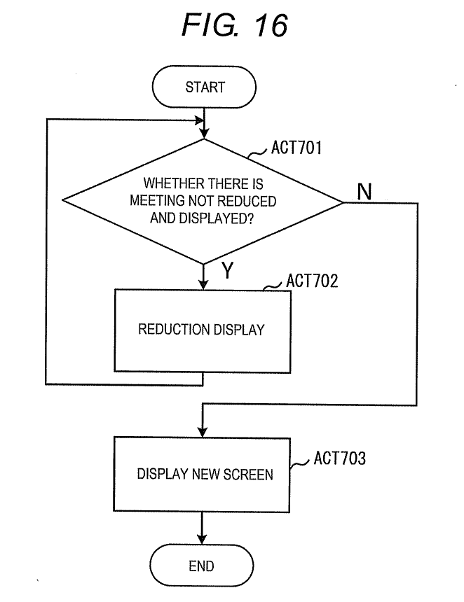

Next, by use of FIG. 16, a description will be made about a processing procedure in which in the client PC 12 and the client PC 13, when a meeting is newly held, another already held meeting screen is reduced and displayed. FIG. 16 shows a processing flow by which the processing of “display meeting screen” at ACT007 of FIG. 9 and ACT503 of FIG. 14 are replaced. Here, the operation of the client PC 12 will be described.

In FIG. 16, after the client PC 12 connects to the new meeting (ACT006 or ACT502), the client PC 12 confirms, based on the managed meeting ID, whether or not there is a meeting which is already being held and its screen is not reduced and displayed (ACT701). If there is such a meeting (ACT701, Y), the client PC 12 reduces the screen size of the meeting screen and displays (ACT702). This processing is continued until a meeting, which is being held and the screen is not reduced and displayed, does not exist. After all the already held meeting screens are reduced and displayed, a large screen is displayed for the newly connected meeting ID (ACT703). Incidentally, the reduced meeting screen is smaller than at least the screen for the new meeting ID.

By adopting the structure as described above, the newly held meeting screen is displayed on the large screen, and the already held meeting screen can be reduced and displayed. While confirming the state of the already held meeting screen on the reduced screen, the user can see the new meeting on the large screen and can operate.

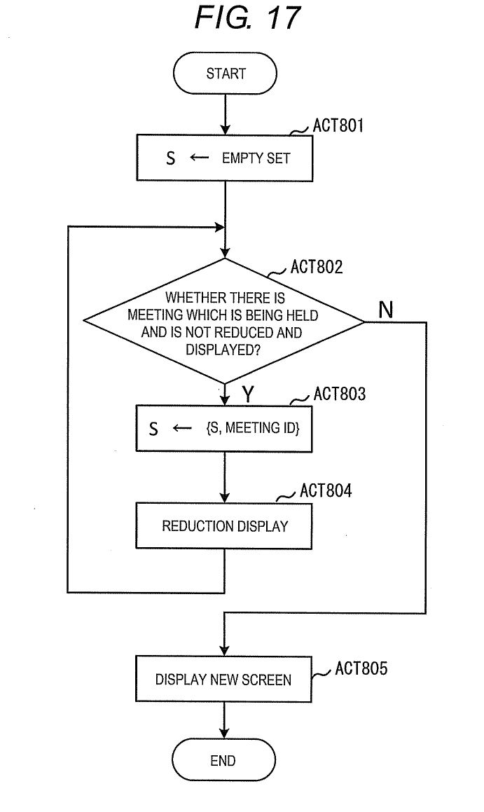

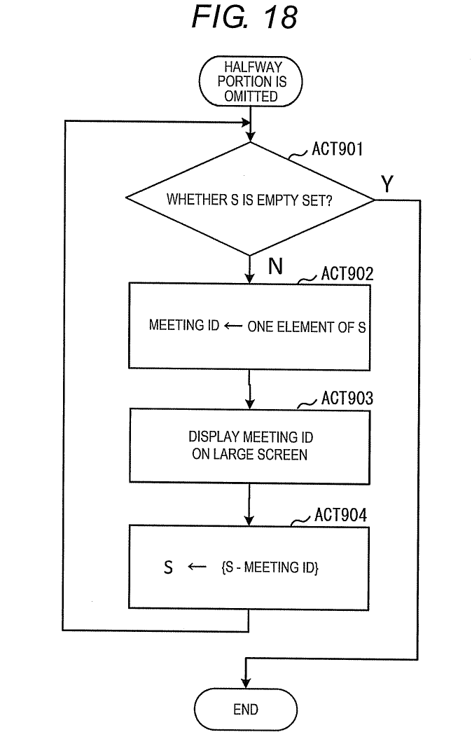

Next, by use of FIG. 17 and FIG. 18, a description will be made about a processing procedure in which in the client PC 12 and the client PC 13, when a meeting is newly held, another already held meeting screen is reduced and displayed, and after the new meeting is ended, the meeting, which was displayed on a large screen until the new meeting started, is returned to be displayed on the original large screen. Similarly to FIG. 16, FIG. 17 shows a processing flow by which the processing of “display meeting screen” at ACT007 of FIG. 9 and ACT503 of FIG. 14 are replaced. Here, the operation of the client PC 12 will be described.

In FIG. 17, first, a set S is made an empty set (ACT801). The client PC 12 confirms whether or not there is a meeting which is already being held and its screen is not reduced and displayed (ACT802). If there is such a meeting (ACT802, Y), the client PC 12 adds this meeting ID to the set S (ACT 803). Further, the client PC 12 reduces and displays the meeting screen corresponding to this meeting ID (ACT804). This processing is continued until a meeting, which is being held and the screen is not reduced and displayed, does not exist. After all the already held meeting screens are reduced and displayed, the client PC 12 displays the meeting on the large screen (ACT805).

Besides, by use of FIG. 18, a description will be made about a procedure in which after “delete meeting screen”, the meeting, which was displayed on the large screen until the new meeting was held, is returned to be displayed on the original large screen. FIG. 18 shows a processing flow after “delete meeting screen” at ACT204 of FIG. 11 or ACT 605 of FIG. 15. In FIG. 18, the set S includes meeting IDs of all meetings which are already being held before the new meeting is held and the screens are not reduced and displayed. First, the client PC 12 confirms whether or not the set S is an empty set (ACT901). If the set is empty (ACT901, Y), there is no meeting which is already being held and is not displayed on a reduced screen, and accordingly, the processing is ended. If the set S is not the empty set (ACT901, N), there is a meeting which is already being held and is not displayed on a reduced screen, and accordingly, the client PC 12 extracts one meeting ID from the set S (ACT902). The client PC 12 displays the meeting screen corresponding to the extracted meeting ID on the large screen (ACT 903). The client PC 12 newly sets IDs except for the extracted meeting ID to the set S. The client PC 12 repeats this processing until the set S becomes the empty set.

By adopting the structure as described above, the meeting, which was displayed on the large screen until the new meeting was started, can be returned to be displayed on the original large screen.

Besides, in FIG. 17 and FIG. 18, not only the meeting ID but also the screen layout information and the object layout information are stored in the set S, and the screen layout information and the object layout information are also extracted after the new meeting is ended, so that these can also be returned. Further, when the screen layer information is stored, if the screen layer values are arranged in an ascending order, the screen can be efficiently returned to the original screen by displaying the screen in sequence from the lower layer screen.

In the embodiment, although the description is made about the case where the function to carry out the embodiment is previously recorded in the device, no limitation is made to this. The same function may be downloaded from the network to the device, or the same function recorded on a recording medium may be installed in the device. As the recording medium, any recording medium, such as a CD-ROM, can be used as long as a program can be recorded and the device can read. Besides, the function previously obtained by the installation or download may realize the function in cooperation with an OS (Operating System) in the device.

Although the screen layout information and the object layout information are illustrated as the information concerning the first to third screens, no limitation is made to this. The information concerning the first to third screens may include, for example, operation history information of the screens besides the layout information.

According to the structure of the embodiment, the display screen can be shared between the specific terminals, and the display screen can be updated by the operation of the user between the specific terminals.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A screen sharing system comprising:
a first client device which updates a display on a first screen in accordance with an operation of a user and transmits, together with identification information of the first screen, information relating to the operation of the user;
a storage unit to store correspondence information in which the identification information of the first screen is correlated with identification information of a plurality of client devices including the first client device;
a control unit which acquires the information relating to the operation and the identification information of the first screen from the first client device, acquires one or a plurality of pieces of identification information of the client devices from the correspondence information stored in the storage unit and the identification information of the first screen, and transmits the identification information of the first screen and the information relating to the operation to one or a plurality of client devices corresponding to the acquired identification information of the client device; and
a second client device which is correlated with the first screen by the correspondence information, receives the identification information of the first screen and the information relating to the operation, and updates to make a display on the first screen identical to the display on the first screen displayed in the first client device in accordance with the information relating to the operation.

2. The system according to claim 1, wherein
the first client device and the second client device display a second screen different from the first screen simultaneously with the first screen,
the first client device updates a display on the second screen in accordance with an operation of the user, and transmits, together with identification information of the second screen, information relating to the operation of the user,
in the correspondence information stored in the storage unit, the identification information of the second screen is correlated with the identification information of the plurality of client devices including the first client device and the second client device,
the control unit acquires the identification information of the second screen and the information relating to the operation of the user on the second screen from the first client device, acquires the identification information of the second client device from the correspondence information and the identification information of the second screen, and transmits the identification information of the second screen and the information relating to the operation on the second screen to the second client device, and
the second client device receives the identification information of the second screen and the information relating to the operation on the second screen, and updates to make a display on the second screen identical to the display on the second screen displayed in the first client device.

3. The system according to claim 1, wherein, when the first client device newly displays a third screen different from the first screen, the control unit sets, in the third screen, information concerning display of the first screen.

4. The system according to claim 3, wherein the control unit displays the third screen on a client terminal of a sharing person on the basis of screen sharing person information requested from the first client device.

5. The system according to claim 3, wherein when the first client device newly displays the third screen, the first client device causes the first screen to be smaller than the third screen and displays the first screen.

6. The system according to claim 3, wherein when the third screen is deleted, the first client device returns the first screen, which is displayed to be small, to an original size and displays the first screen.

7. The system according to claim 1, wherein the information relating to the operation includes information relating to a size change of an object displayed in the first screen, information relating to a position movement, information relating to an inclination change, and information relating to a hierarchical order of display.

8. The system according to claim 1, wherein
the screen sharing system is a meeting system used in a meeting among users,
in the correspondence information stored in the storage unit, identification information of a first meeting to be held and the first screen are correlated with each other, and
a material image of the first meeting is displayed in the first screen.

9. An information processing apparatus comprising:
an interface unit to receive identification information of a first screen and information relating to an operation of a user, which are transmitted from a first client device to update a display on the first screen in accordance with the operation of the user;
a storage unit to store correspondence information in which the identification information of the first screen is correlated with identification information of a plurality of client devices including the first client device; and
a control unit which acquires one or a plurality of pieces of identification information of the client devices from the correspondence information stored in the storage unit and the identification information of the first screen received by the interface unit, and transmits the identification information of the first screen and the information relating to the operation to one or a plurality of client devices corresponding to the acquired identification information of the client device.

10. A storage medium storing a program, wherein the program comprises:
receiving identification information of a first screen and information relating to an operation of a user, which are transmitted from a first client device to update a display on the first screen in accordance with the operation of the user;
storing correspondence information in which the identification information of the first screen is correlated with identification information of a plurality of client devices including the first client device;
acquiring one or a plurality of pieces of identification information of the client devices from the correspondence information and the received identification information of the first screen; and
transmitting the identification information of the first screen and the information relating to the operation to one or a plurality of client devices corresponding to the acquired identification information of the client device.
